(19) United States
(12) Patent Application Publication
(10) Pub. No.: US 2014/0207487 A1
(43) Pub. Date: Jul. 24, 2014

(54) MEDICAL DIARY SYSTEM

(71) Applicants: Jerry G. Blaivas, New York, NY (US); Stuart K.J. Smyth, Newmarket, NH (US)

(72) Inventors: Jerry G. Blaivas, New York, NY (US); Stuart K.J. Smyth, Newmarket, NH (US)

(21) Appl. No.: 13/747,511

(22) Filed: Jan. 23, 2013

(51) Int. Cl. G06F 19/00

(52) U.S. Cl. CPC G06F 19/322
USPC 705/3

(57) ABSTRACT

Methods, systems and computer readable media for a computerized medical diary system are described.

### TECHNICAL FIELD

Some implementations relate generally to medical information systems and, more particularly, to methods, systems and computer readable media for computerized medical diaries.

### BACKGROUND

Often, physicians and/or patients may have limited time available for medical exams and consultation. In order to best diagnose and treat a patient, a physician may need to obtain information regarding the patient's symptoms. The information gathering process may consume a significant portion of the time available for the patient.

Also, when attempting to provide information based on memory, a patient may provide inaccurate information to a physician.

Some implementations were conceived in light of the above-mentioned problems and limitations, among other things.

### BRIEF DESCRIPTION OF THE DRAWINGS

FIG. 1 is a diagram of an example medical diary system in accordance with at least one implementation.

FIG. 2 is a flowchart of an example medical diary method in accordance with at least one implementation.

FIG. 3 is a diagram of an example computer system in accordance with at least one implementation.

FIGS. 4-8 show example user interface screens for a medical diary system in accordance with at least one implementation.

### DETAILED DESCRIPTION

It will be appreciated that although the example implementations described herein are directed to urination conditions, the medical diary system can be applied to any suitable medical condition where use of a computerized medical diary may be desired.

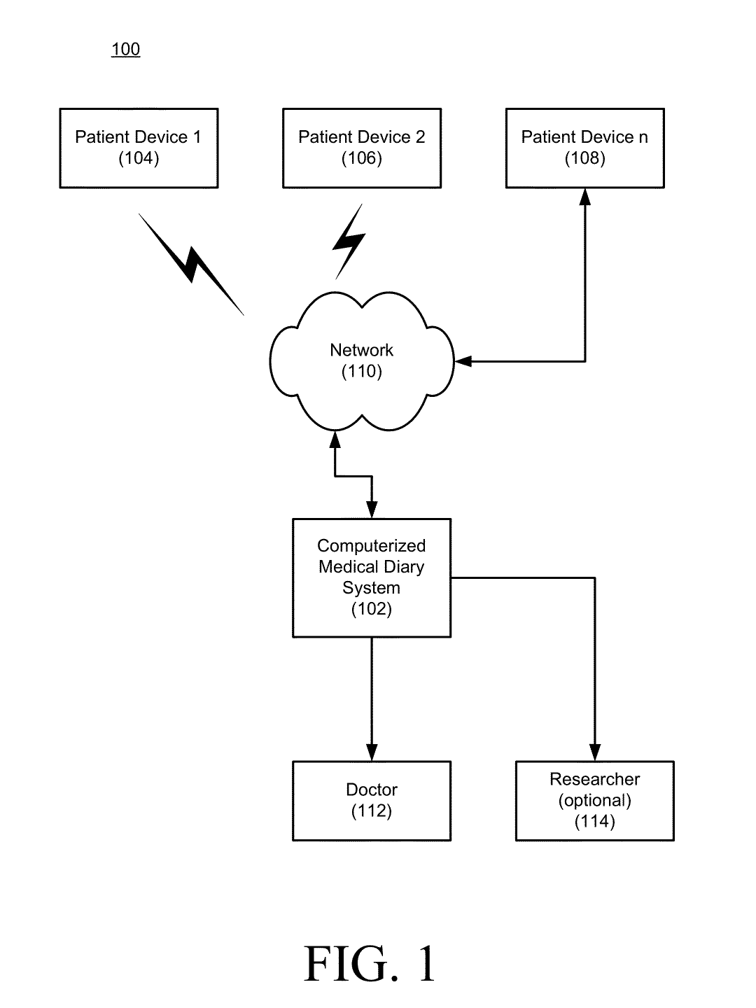

FIG. 1 is a diagram of an example medical diary environment 100 in accordance with at least one implementation. In particular, the environment 100 can include a computerized medical diary system 102. A plurality of user devices (104-108) can communicate with the computerized medical diary system 102 via network 110. The computerized medical diary system 102 can provide medical diary information for one or more patients to a physician (112) and, optionally, to a researcher 114.

The patient devices (104-108) can include a desktop computer, laptop computer, tablet computer, wireless smart phone, electronic book reader, media player and/or the like. The network network 110 can include a wired or wireless network (e.g., the Internet). One or more patient devices (e.g., 104 and 106) can communicate wirelessly with the network 110, while other patient devices (e.g., 108) can communicate via a wired interface.

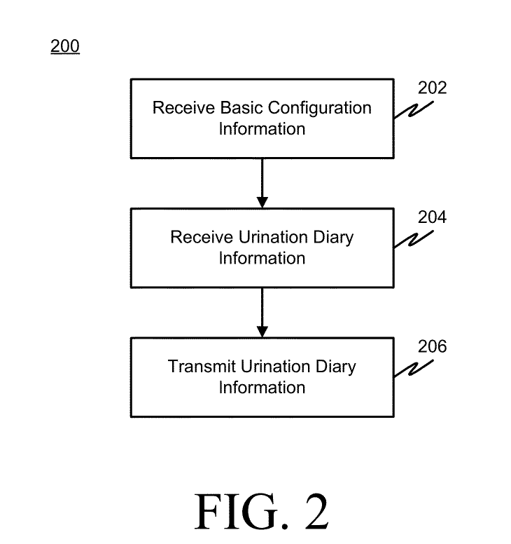

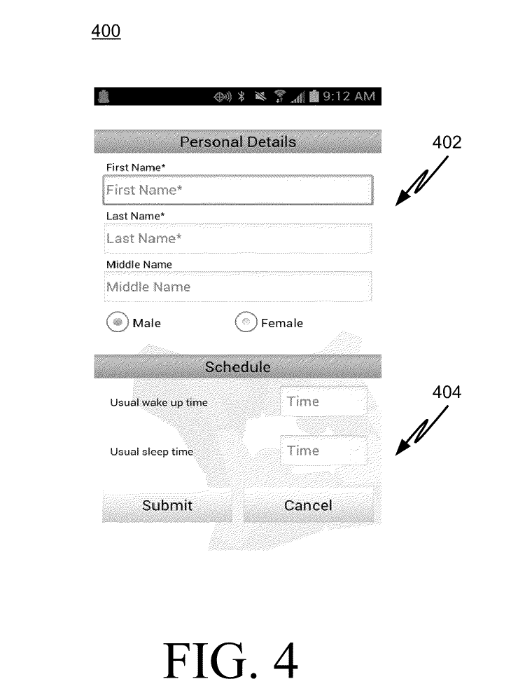

FIG. 2 is a flowchart of an example medical diary method in accordance with at least one implementation. Processing begins at 202, where a system receives basic configuration information from a patient. For example, the computerized medical diary system 102 can receive the basic configuration information via a user interface form (e.g., FIGS. 4, 7 and 8). Processing continues to 204.

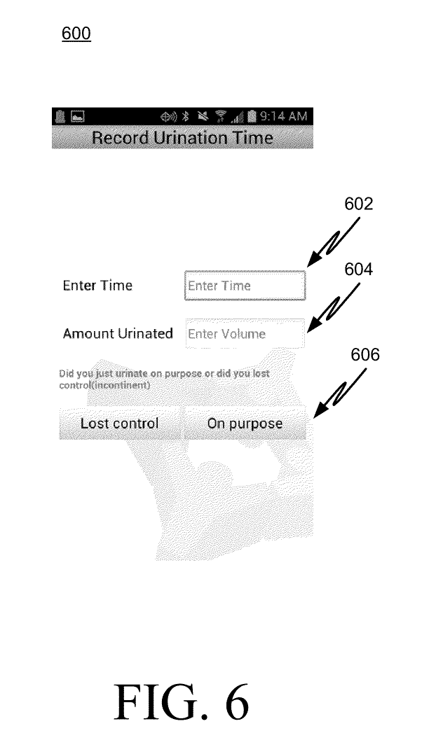

At 204, the system receives urination diary information. For example, the computerized medical diary system 102 could receive urination diary information from a user device (e.g., 104-108). The urination diary information can be entered via a user interface (e.g., FIG. 6). Processing continues to 206.

At 206, the urination diary information can be transmitted from the user device and/or server to one or more recipients. For example, urination diary information can be collected in a user device (104-108) and transmitted according to an application program setting to the computerized medical diary system 102, which in turn can transmit the diary information to a physician (112) and/or a researcher (114).

It will be appreciated that 202-206 can be repeated in whole or in part in order to accomplish a contemplated medical diary task.

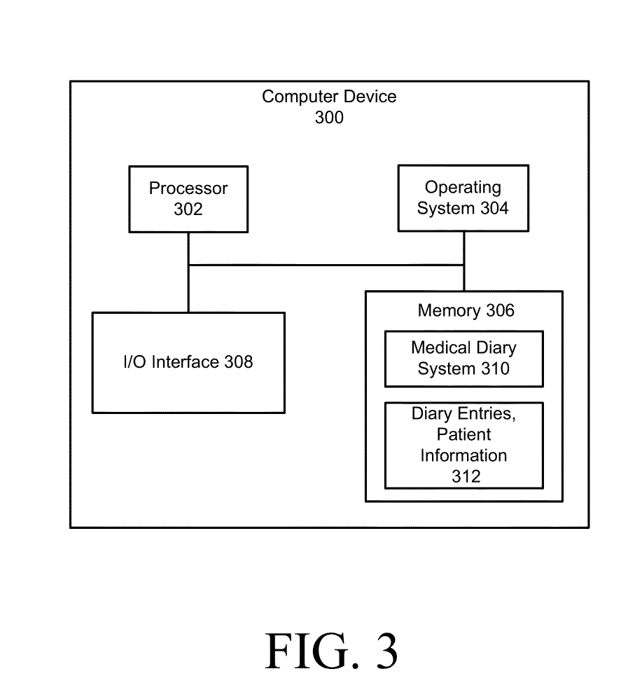

FIG. 3 is an example computer system 300 for computerized medical diaries in accordance with at least one implementation. The server device 300 includes a processor 302, an operating system 304, a memory 306 and an I/O interface 308. The memory 306 can include a medical diary system application 310 and one or more diary entries and/or patient information records 312.

In operation, the processor 302 may execute the application 310 stored in the memory 306. The application 310 can include software instructions that, when executed by the processor, cause the processor to perform operations for a computerized medical diary in accordance with the present disclosure (e.g., performing one or more of steps 202-206 described above).

The application program 310 can operate in conjunction with the one or more diary entries and/or patient information records 312 and the operating system 304.

FIGS. 4-8 show example user interface screens for a medical diary system in accordance with at least one implementation. In particular, FIG. 4 shows an example user interface screen 400 that includes a section that permits a user to enter personal details 402 (e.g., first name, middle name, last name and gender). The interface 400 also includes a section for entering schedule information 404 (e.g., usual wake up time and usual bed time).

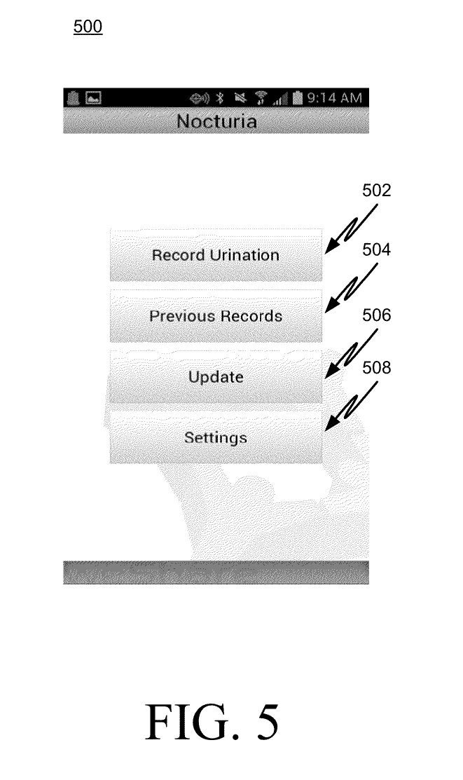

FIG. 5 shows a main menu user interface 500 that includes selections for recording urination 502, previous records 504, update 506 and settings 508. The record urination selection 502 user interface screen can permit a patient to enter a urination diary entry via a user interface screen (e.g., 600 of FIG. 6).

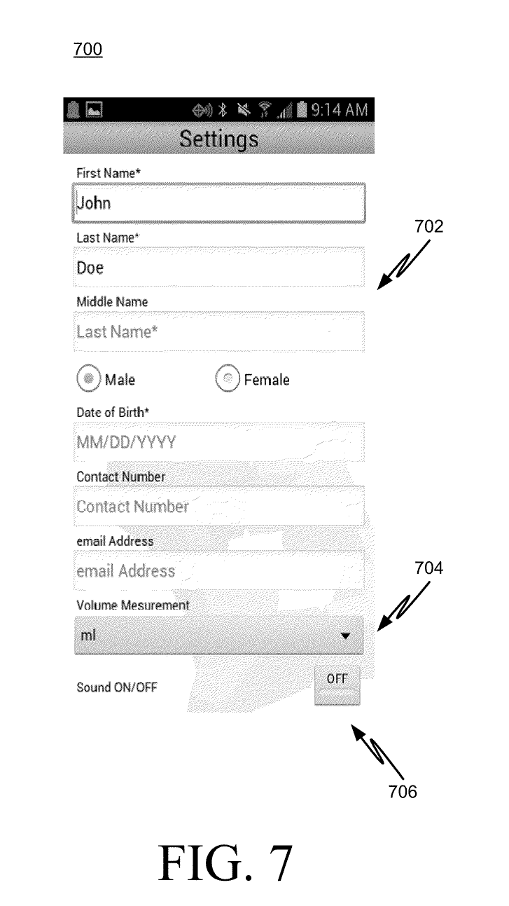

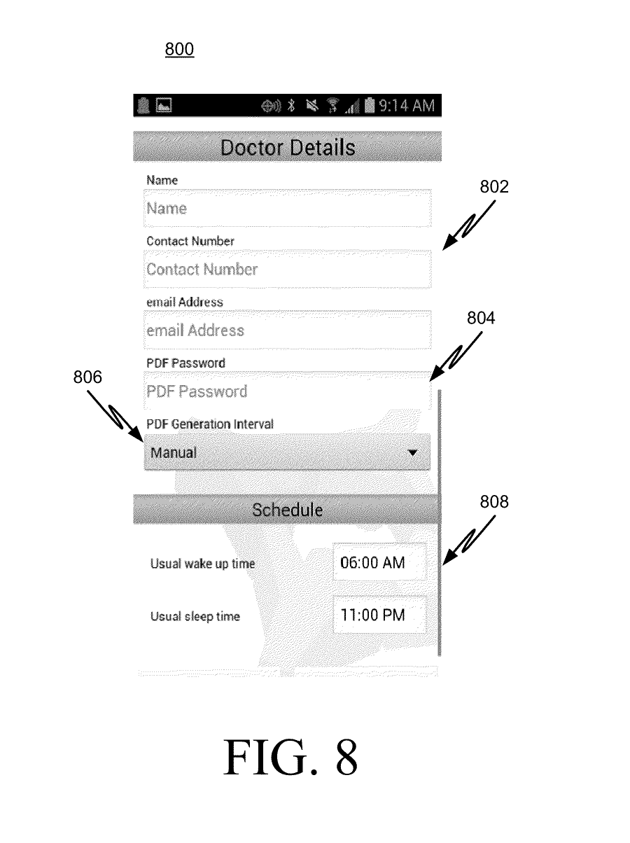

The previous records selection 504 can permit a patient to view previous records. The update selection 506 checks for an update for the application program. The settings selection 508 can access settings user interfaces (e.g., FIGS. 7 and 8).

FIG. 6 shows a record urination time user interface 600. The record urination time user interface 600 can include an element for entering: time 602, urination amount 604 and whether the urination was on purpose or due to lost control 606. In addition to the examples information

FIG. 7 shows a settings user interface screen 700 that includes a section for patient information 702 (e.g., name, gender, contact number, and email address). The interface 700 also includes an element for selecting volume measurement units 704 (e.g., ml, cup, cc and oz). The interface 700 also includes an element for turning sound on or off (706).

FIG. 8 shows a continuation 800 of the setting screen of FIG. 7. In the user interface continuation 800, there are sections for doctor details 802 (e.g., name, contact number and email address). There is a section for a PDF password 804 and a PDF generation interval 806 (e.g., manual, every 24 hours, once a week). There is also a schedule section 808 that includes a usual wake up time and a usual sleep time.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and publishing arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for medical diaries.

While the disclosed subject matter has been described in conjunction with a number of implementations, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method comprising:
receiving, at one or more processors, patient configuration information;
receiving, at the one or more processors, a urination diary entry, wherein the urination diary entry includes a time, a volume and an indication of whether the urination was on purpose or a result of incontinence; and
providing the urination diary entry to one or more external systems.

2. The method of claim 1, wherein the patient configuration information includes a unit indication associated with the volume value of the urination diary entry.

3. The method of claim 1, wherein the patient configuration information includes fields for first name, last name, middle name, gender, date of birth, contact number and email address.

4. The method of claim 1, wherein the patient configuration information includes a unit indication associated with the volume.

5. The method of claim 1, wherein the patient configuration information includes physician information.

6. The method of claim 1, wherein the patient configuration information includes a password for the reports generated by the system.

7. The method of claim 1, wherein the patient configuration information includes a time interval at which to generate reports.

8. The method of claim 1, wherein the one or more external systems include one or more of a physician computer system and a researcher computer system.

9. A system comprising:
one or more processors configured to perform operations, the operations including:
receiving patient configuration information;
receiving a urination diary entry, wherein the urination diary entry includes a time, a volume and an indication of whether the urination was on purpose or a result of incontinence; and
providing the urination diary entry to one or more external systems.

10. The system of claim 9, wherein the patient configuration information includes a unit indication associated with the volume value of the urination diary entry.

11. The system of claim 9, wherein the patient configuration information includes fields for first name, last name, middle name, gender, date of birth, contact number and email address.

12. The system of claim 9, wherein the patient configuration information includes a unit indication associated with the volume.

13. The system of claim 9, wherein the patient configuration information includes physician information.

14. The system of claim 9, wherein the patient configuration information includes a password for the reports generated by the system.

15. The system of claim 9, wherein the patient configuration information includes a time interval at which to generate reports.

16. The system of claim 9, wherein the one or more external systems include one or more of a physician computer system and a researcher computer system.
